(19) United States
(12) Patent Application Publication
(10) Pub. No.: US 2024/0304011 A1
(43) Pub. Date: Sep. 12, 2024

(54) SUBTITLE POSITIONING BASED ON SALIENCY DETECTION

(71) Applicant: Intel Corporation, Santa Clara, CA (US)

(72) Inventors: Yaoxin SHI, Shanghai (CN); Bo ZHAO, Shanghai (CN); Fuguang ZHENG, Shanghai (CN)

(21) Appl. No.: 18/217,497

(22) Filed: Jun. 30, 2023

(30) Foreign Application Priority Data
Mar. 6, 2023 (WO) PCT/CN2023/079885

(51) Int. Cl. G06V 30/14; G06V 30/146

(52) U.S. Cl. CPC G06V 30/1444; G06V 30/147

(57) ABSTRACT

A system that includes a system to analyze a frame of a video and to identify one or more bounding regions in the frame that correspond to regions of interest; select a location of a text bounding region in the frame that does not overlap with the one or more bounding regions, wherein the text bounding region in the frame is associated with text; and cause the text to be displayed in the text bounding region corresponding to the selected location.

### RELATED APPLICATION

This application claims the benefit of priority to Patent Cooperation Treaty (PCT) Application No. PCT Application No. PCT/CN2023/079885 filed Mar. 6, 2023. The entire contents of that application are incorporated by reference.

### BACKGROUND

Video subtitles or video captions (e.g., closed captioning) include transcription of spoken words and sounds in multimedia contents to text. Video subtitles or video captions can be displayed with video as part of at least television, playing a video clip on a personal computer (PC), or browsing a video website. Original video frames can be composed with video subtitles and then displayed on the screen. A positioning of subtitles on screen can affect user's video viewing experience.

Some online video websites allow manual adjustment of a position of subtitles on a screen. If the subtitles occlude information in the picture, a user can use a mouse to re-position (drag) the subtitle to another position on the screen. However, re-positioning subtitles may not be feasible for television if there is no input system to re-position the subtitles.

Mocanu and Tapu, “Automatic Subtitle Synchronization and Positioning System Dedicated to Deaf and Hearing Impaired People” (IEEE Access 2021) introduces an automatic subtitle positioning system that is based on text information in the image. Text information is part of a region of interest (ROI) in an image. Other important areas of a screen, such as a human face in a movie or a ball in a sports broadcast, may be occluded by the subtitles.

### BRIEF DESCRIPTION OF THE DRAWINGS

So that the manner in which the features of the present embodiments can be understood in detail, a more particular description of the embodiments, briefly summarized above, may be had by reference to embodiments, some of which are illustrated in the appended drawings. It is to be noted, however, that the appended drawings illustrate only typical embodiments and are therefore not to be considered limiting of its scope.

FIG. 1 depicts an example of subtitle positioning.

FIG. 2 depicts an example system.

FIG. 3 depicts an example of a user interface that can provide a setting for subtitle placement settings.

FIG. 4 depicts an example of operations of subtitle location determination.

FIG. 5 illustrates operations of saliency detection and position calculation.

FIG. 6 shows saliency detection artificial intelligence (AI) models.

FIG. 7 depicts an example process to determine a subtitle position in a frame.

FIG. 8 depicts examples of subtitle placements.

### DETAILED DESCRIPTION

At least to attempt to provide automatic subtitle positioning without manual input of a subtitle position by a user and reduce a likelihood that sub-titles overwrite areas of interest in a video, some examples set subtitle position based on saliency-detection to detect areas of interest in a video frame and attempt to avoid overlapping areas of interest by subtitles. Some examples can be implemented as a processor-executed software or circuitry to automatically find a position for the subtitles in video frames. Some examples can be used to place subtitles at for online video, live streaming, television (TV) broadcasting, and video software vendors. Some examples can automatically position video subtitles based, at least, on (1) artificial intelligence (AI) based saliency detection (e.g., neural network) to divide a video frame into one or more regions of interest and one or more regions that are not of interest and (2) a time adaptive scheme to select a position for the sub-titles for different frames of video.

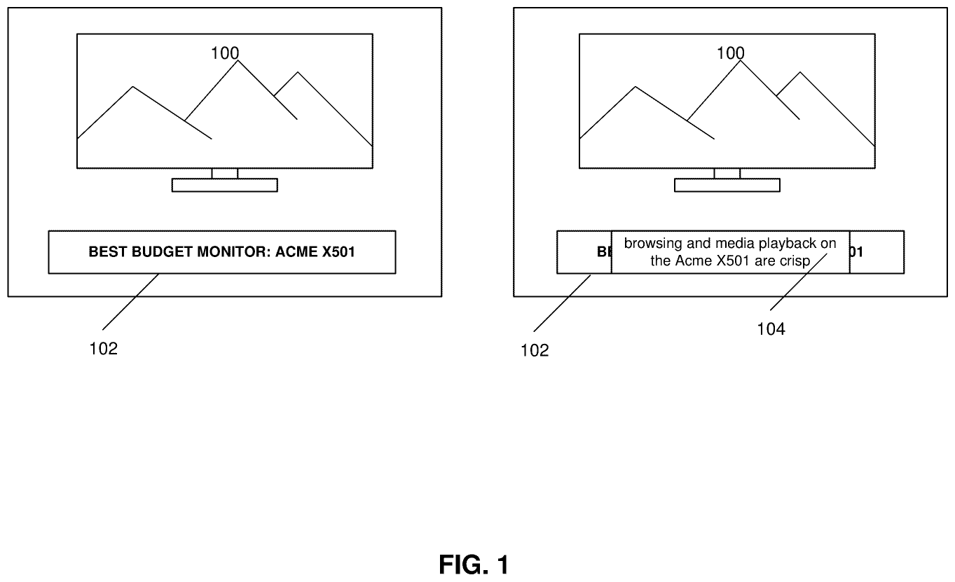

As described earlier, in some cases, subtitles can be positioned in a portion of a screen that would occlude information of interest to a user. FIG. 1 depicts an example of subtitle positioning. Caption 102 is displayed and can be a region of interest to a viewer as caption 102 conveys information. For example, caption 102 can provide information concerning display 100. However, if video subtitles are turned on, caption 102 is covered by subtitle text 104 and subtitle text 104 can obfuscate caption 102. As described herein, at least to attempt to reduce a likelihood that information, images, or video of interest are not covered by a subtitle, various examples can process image data of a frame of video for one or more areas of interest and automatically select a position in the frame of video in which to display a subtitle. Various examples herein can consider changes in one or more areas of interest from frame-to-frame to select one or more locations to position a subtitle.

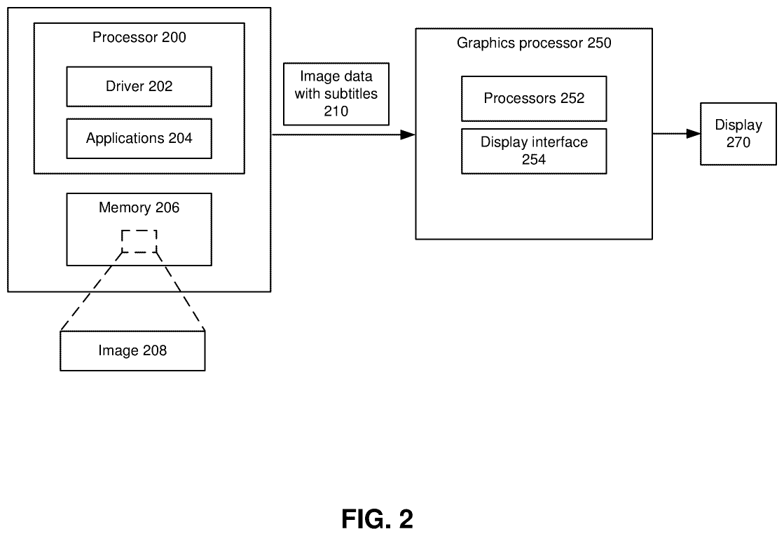

FIG. 2 depicts an example system. Processor 200 can include one or more of: one or more processors; one or more cores; one or more accelerators; one or more application specific integrated circuits (ASICs); one or more field programmable gate arrays (FPGAs); one or more graphics processing units (GPUs); one or more memory devices; or others. Memory 204 can include one or more of: one or more registers, one or more general register file (GRF), one or more arithmetic logic units (ALUs), one or more accumulators, one or more cache devices (e.g., level 1 cache (L1), level 2 cache (L2), level 3 cache (L3), last level cache (LLC)), volatile memory device, non-volatile memory device, or persistent memory device. For example, memory 204 can include static random access memory (SRAM) memory technology or memory technology consistent with high bandwidth memory (HBM), or double data rate (DDR), among others.

Application 204 can include applications such as a media player, web browsers, video editor, social media application, video game, or others. Driver 202 executed by processor 200 can provide access to display interface 254 to an applications 204 executing on processor 200. In some examples, driver 202 can process image file 208 to identify one or more potential locations on a frame of video or an image in which to position a subtitle based on one or more regions of interest to a viewer and considering frame-to-frame subtitle location, as described herein. Image file 208 can include video, one or more still images, audio, metadata, 2D or 3D graphics images generated by a graphics processing pipeline, and so forth. Display interface 254 can provide video frames or images with subtitles 210 to display 270 for display.

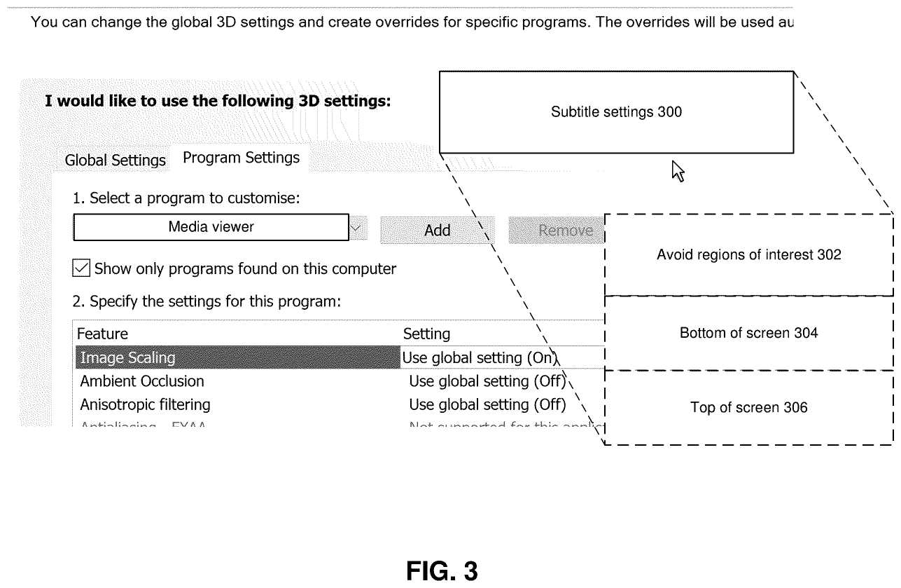

FIG. 3 depicts an example of a user interface that can provide a setting for subtitle placement settings. For example, when selected, subtitle settings menu 300 can provide options of subtitle placement of at least avoid regions of interest 302, bottom of screen 304, or top of screen 306. Other subtitle settings are possible such as specifying what types of regions of interest to avoid (e.g., people, text, moving objects, and so forth).

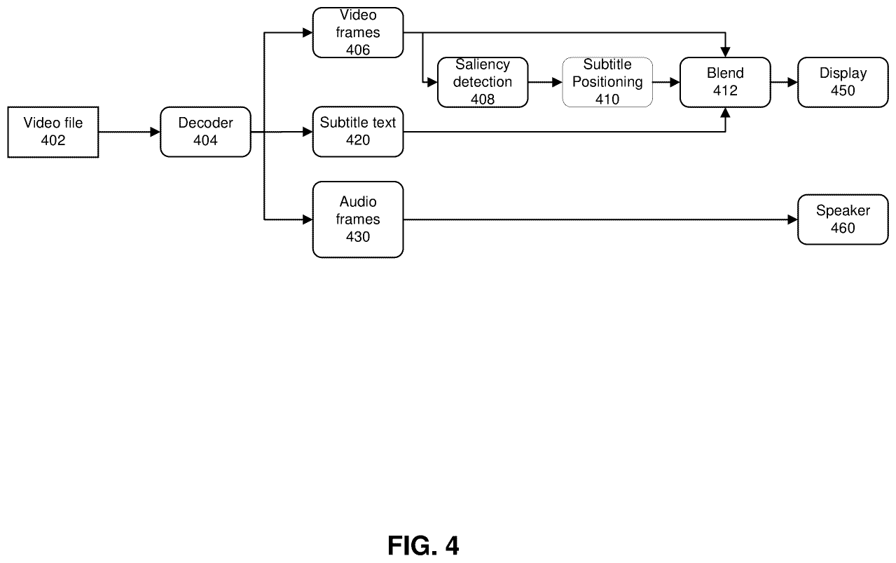

FIG. 4 depicts an example of operations of subtitle location determination. The process can be performed along with part of video decoding and playback by one or more of: a processor that executes instructions, a GPU, circuitry, accelerator, application specific integrated circuit (ASIC), or others. Video file 402 can be decoded by decoder 404 and decoder 404 can perform video decoding based on one or more media encoding formats, including, but not limited to Moving Picture Experts Group (MPEG) formats such as MPEG-2, Advanced Video Coding (AVC) formats such as H.264/MPEG-4 AVC, H.265/HEVC, Alliance for Open Media (AOMedia) VP8, VP9, as well as the Society of Motion Picture & Television Engineers (SMPTE) 421M/VC-1, and Joint Photographic Experts Group (JPEG) formats such as JPEG, and Motion JPEG (MJPEG) formats.

Decoder 404 can output video frames 406 for processing. In some examples, decoder 404 can generate subtitle text 420. For example, subtitle text 420 can be generated based on closed captioning (CC) data associated with video file 402 that provides a transcript of audio and can be synchronized with audio playback. In some examples, subtitle text can be encoded into one or more associated video frames and decoding video can provide subtitle text for each frame. In some examples, subtitle text 420 can be generated by transcribing audio generated from decoding video file 402. In some examples, subtitle text 420 can be retrieved from a file associated with video file 402.

Saliency detection 408 can detect images that are considered salient or of interest to a viewer and that are less likely to be covered by subtitles. For example, a largest person or people in a frame can be considered salient. For example, a car or plane in a frame can be considered salient. For example, a centered image in a frame can be considered salient. For example, text in a frame can be considered salient. For example, the following can be considered non-salient: lake region, sky region, uniform colored region (e.g., football or baseball field), or others. In some examples, salient images can be identified by use of neural networks such as convolutional neural networks (CNNs). Neural networks can be trained to perform inference of features in a visual feature representation. A CNN or other neural network can be trained with video and games and tag images in video and games to identify salient regions. For example, a largest person in a frame can be considered salient. For example, a car or plane can be considered salient. For example, a centered image can be considered salient. For example, an image of a human can be considered salient. For example, the following can be considered non-salient: lake region, sky region, uniform colored region (e.g., house, football field, or baseball field).

Subtitle positioning 410 can select one or more positions in a frame to place subtitle text 420 to avoid salient region(s) that include salient image(s). In some examples, a position of the subtitle text can be selected on a frame-by-frame basis. Subtitle text 420 can be bounded by a rectangle or other shape and subtitle positioning 410 can attempt to reduce overlap between the rectangle or other shape and the salient region(s). In some examples, a size of subtitle text 420 can be reduced so that subtitle text 420 can be positioned within a region that does not overlap with salient region(s). In some examples, subtitle text 420 can be positioned within

Position of subtitle text 420 on a frame can be set by pixel coordinates such as top left coordinates of a bounding shape of subtitle text 420. Blend 412 can position subtitle text 420 in a position specified by subtitle positioning 410. The composite image can be output to display 450 for display, storage, or streaming. Audio frames 430 potentially corresponding to subtitle text 420 can be output to speaker 460, stored, or streamed.

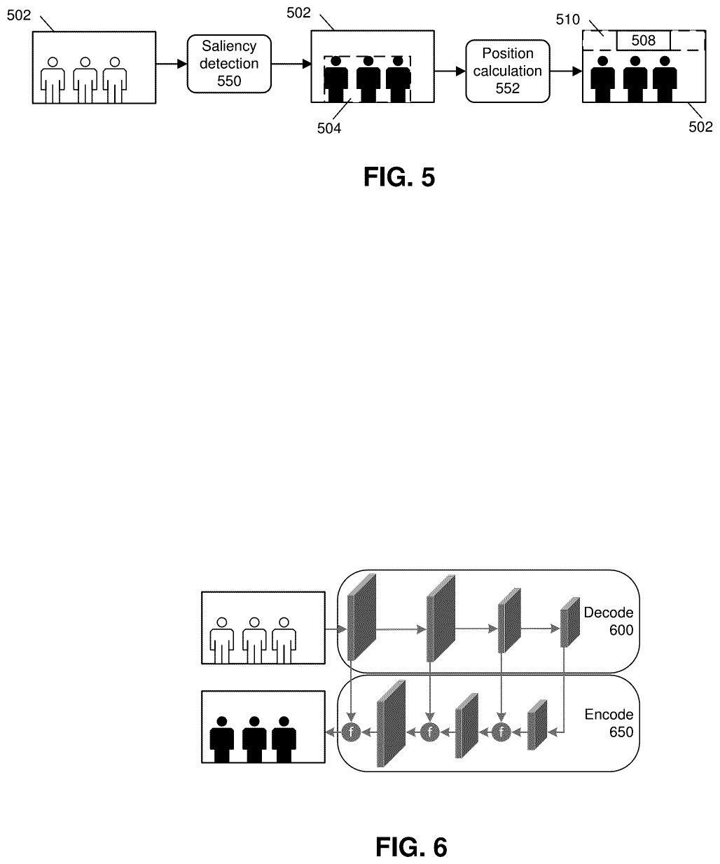

FIG. 5 illustrates operations of saliency detection and position calculation. Saliency detection 550 can be performed on frame 502 to identify one or more salient objects. For example, in frame 502, region 504 can be identified to include salient images (e.g., persons). Position calculation 552 can determine a position of a subtitle text in frame 502 that does not overlap with salient region 504. For example, region 510 can be selected as a potential subtitle text region. Position calculation 552 can position subtitle text 508 in a center of region 510. In some examples, region 510 can be offset from an edge of a frame so that subtitle text 508 does not contact the edge of a frame. However, subtitle text 508 may contact the edge of a frame.

Position calculation 552 can be performed in a client and/or server side. For example, a client device can include one or more of a personal computer, laptop, mobile phone, smart phone, television, or other device. For example, a server can include one or more of a server, content delivery network (CDN), or other device.

FIG. 6 shows saliency detection artificial intelligence (AI) models. For example, multiple saliency detection AI models based on a decoder-encoder architecture can be utilized. At least one model can produce saliency maps of salient objects to identify salient regions (if any). Based on saliency maps from decode operation 600, one or more positions for subtitles in a video frame can be identified. To improve the saliency detection's performance and stability, object tracking can be applied (e.g., Kernelized correlation filter (KCF)) to consecutive frames in order to select a subtitle position. In some examples, locations of subtitles can be determined based on saliency data from multiple frames in order to reduce changes to subtitle position.

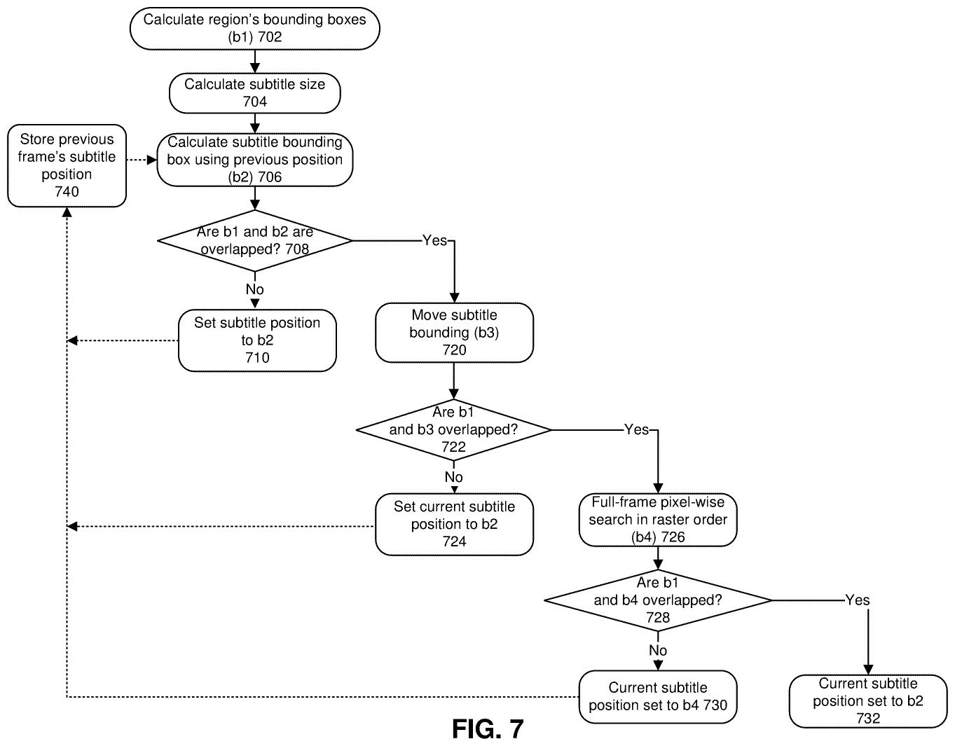

FIG. 7 depicts an example process to determine a subtitle position in a frame. At 702, a saliency map's bounding box (b1) can be calculated. As the saliency map may not be a continuous block (e.g., a salient area may be in different positions in consecutive frames), b1 can represent multiple bounding boxes. At 704, a subtitle size can be calculated based on the subtitle information, such as number of letters and lines and size of font. At 706, a size of the subtitle's bounding box (b2) can be calculated. In some examples, the top-left pixel position of the bounding box (b2) can be the same as previous frame's subtitle's top-left pixel position, but a size of b2 may differ from that of a previous frame. The bounding box (b2) width and height can be set to a size value from operation 706.

In some examples, to attempt to smooth a transition of subtitles' position, a weighted moving average of position b2 can be used to calculate the subtitle bounding box's top left pixel position as:

Pos_{actual}=α*Posₚᵣₑᵥ+(1−α)*Pos_{new}
α can represent an experimental value chosen as user, video provider, or manufacturer defined.

At 708, a determination can be made if b1 and b2 are overlapped. In other words, a determination can be made if the subtitle bounding box overlaps with the salient map's bounding box. Based on a non-overlap of the subtitle bounding box with the salient map's bounding box, at 710, the subtitle bounding box (b2) position can be set as the position of b2 in a prior frame. Based on an overlap of the subtitle bounding box with the salient map's bounding box, at 720, the subtitle bounding box (b2) can be moved to another position (b3) by movement in one of more of four directions: up, down, left, or right.

At 722, a determination can be made if a position of the subtitle bounding box at position b3 overlaps with the salient region bounding box. A bounding box can be a region of a solid color on screen and can overwrite pixels of a video frame or image. Based on non-overlap of the subtitle bounding box at position b3 with the salient region bounding box (b2), at 724, position b3 can be used as the subtitle position. At 740, this position can be saved for a next frame's calculation. Operation 722 can attempt to reduce movement of subtitle position (despite subtitle text changing) from frame to frame of video by finding region of frame that is non-salient for multiple consecutive frames. Note that operations 720 and 722 can repeat a configured integer X number of times until operation 722 yields a true result. In some examples, a size of the subtitle bounding box or associated text can be reduced one or more times and operations 720 and 722 can repeat until a true result occurs. Based on overlap of the subtitle bounding box at position b3 with the salient region bounding box (b2) after repeat of 720 and 722 an integer X number of times, at 726, a full frame per-pixel search can be performed in raster scan order to find a position (b4) that is not overlapped with b1. If b4 is found, at 732, b4 can be used as the subtitle position and the position is saved at 740. If b4 is not found, at 730, a previous frame's subtitle position (b2) can be used for current frame.

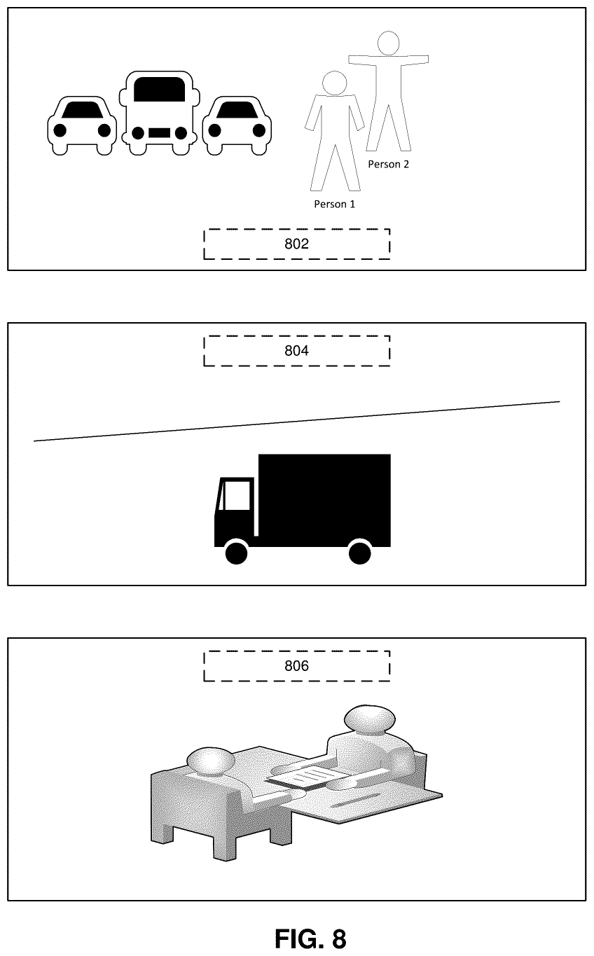

FIG. 8 depicts examples of subtitle placements. For example, subtitles 802 can be placed at a region centered in a bottom of a screen so to not overlap with salient objects such as persons 1 and 2 and vehicles. For example, subtitles 804 can be placed at a region centered in a top of a screen so to not overlap with salient objects such as a van or skyline. For example, subtitles 806 can be placed at a region centered in a top of a screen so to not overlap with salient objects such as persons at a table.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or combination thereof, including “X, Y, and/or Z.””

Illustrative examples of the devices, systems, and methods disclosed herein are provided below. An embodiment of the devices, systems, and methods may include one or more, and combination of, the examples described below.

Example 1 includes one or more examples and includes: at least one non-transitory computer-readable medium comprising instructions store thereon, that if executed by one or more processors, cause the one or more processors to: for a frame of a video: identify one or more bounding regions in the frame that correspond to regions of interest; select a location of a text bounding region in the frame that does not overlap with the one or more bounding regions, wherein the text bounding region in the frame is associated with text; and cause the text to be displayed in the text bounding region corresponding to the selected location.

Example 2 includes one or more examples, wherein the identify one or more bounding regions in the frame that correspond to regions of interest is based on a neural network trained based on regions of interest.

Example 3 includes one or more examples, wherein the regions of interest comprise one or more of: a largest image in a frame, a moving image, a centered image, text, or an image of a human.

Example 4 includes one or more examples, wherein the regions of interest exclude a solid colored region.

Example 5 includes one or more examples, wherein the text to be displayed in the region comprises subtitles or closed captioning (CC) text.

Example 6 includes one or more examples, wherein the select a location of a text bounding region in the frame that does not overlap with the one or more bounding regions is based on locations of text bounding regions in multiple frames.

Example 7 includes one or more examples, wherein the select a location of a text bounding region in the frame that does not overlap with the one or more bounding regions is based on locations of text bounding regions in multiple frames of the video and reduces an amount of movement of the locations of text bounding regions in multiple frames.

Example 8 includes one or more examples, wherein the select a location of a text bounding region in the frame that does not overlap with the one or more bounding regions is based on a per-pixel raster order scan of a frame.

Example 9 includes one or more examples, wherein the select a location of a text bounding region in the frame that does not overlap with the one or more bounding regions comprises reduce a size of the bounding region in the frame until identifying a location of a text bounding region in the frame that does not overlap with the one or more bounding regions.

Example 10 includes one or more examples, wherein the frame of video comprises one or more of: text, audio, graphics, video, holographic images or video, or audio.

Example 11 includes one or more examples, and includes an apparatus that includes: at least one processor and at least one memory comprising stored thereon, that if executed by the at least one processor, cause the at least one processor to: for a frame of a video file: identify one or more bounding regions in the frame that correspond to regions of interest; select a location of a text bounding region in the frame that does not overlap with the one or more bounding regions, wherein the text bounding region in the frame is associated with text; and cause the text to be displayed in the text bounding region corresponding to the selected location.

Example 12 includes one or more examples, wherein the identify one or more bounding regions in the frame that correspond to regions of interest is based on a neural network trained based on regions of interest.

Example 13 includes one or more examples, wherein the regions of interest comprise one or more of: a largest image in a frame, a moving image, a centered image, text, or an image of a human.

Example 14 includes one or more examples, wherein the text to be displayed in the region comprises subtitles or closed captioning (CC) text.

Example 15 includes one or more examples, wherein the select a location of a text bounding region in the frame that does not overlap with the one or more bounding regions is based on locations of text bounding regions in multiple frames.

Example 16 includes one or more examples, wherein the select a location of a text bounding region in the frame that does not overlap with the one or more bounding regions is based on a per-pixel raster order scan of a frame.

Example 17 includes one or more examples, and includes a method that includes: for frames of a video file: determining a location of subtitle text by: based on a user-input configuration specifying to select a location of display of the subtitle text to avoid images of interest: determining one or more regions of interest in the frame and selecting a location of the subtitle text to avoid overlapping a bounding box surrounding the subtitle text with the one or more regions of interest.

Example 18 includes one or more examples, wherein the regions of interest comprise one or more of: a largest image in a frame, a moving image, a centered image, text, or an image of a human.

Example 19 includes one or more examples, wherein the selecting a location of the subtitle text to avoid overlapping a bounding box surrounding the subtitle text with the one or more regions of interest is based on a per-pixel raster order scan of a frame.

Example 20 includes one or more examples, wherein the selecting a location of the subtitle text to avoid overlapping a bounding box surrounding the subtitle text with the one or more regions of interest comprises reducing a size of the bounding box in the frame until identifying a location of the bounding box in the frame that does not overlap with the one or more regions of interest.

What is claimed is:

1. At least one non-transitory computer-readable medium comprising instructions store thereon, that if executed by one or more processors, cause the one or more processors to:
for a frame of a video:
identify one or more bounding regions in the frame that correspond to regions of interest;
select a location of a text bounding region in the frame that does not overlap with the one or more bounding regions, wherein the text bounding region in the frame is associated with text; and
cause the text to be displayed in the text bounding region corresponding to the selected location.

2. The computer-readable medium of claim 1, wherein the identify one or more bounding regions in the frame that correspond to regions of interest is based on a neural network trained based on regions of interest.

3. The computer-readable medium of claim 1, wherein the regions of interest comprise one or more of: a largest image in a frame, a moving image, a centered image, text, or an image of a human.

4. The computer-readable medium of claim 1, wherein the regions of interest exclude a solid colored region.

5. The computer-readable medium of claim 1, wherein the text to be displayed in the region comprises subtitles or closed captioning (CC) text.

6. The computer-readable medium of claim 1, wherein the select a location of a text bounding region in the frame that does not overlap with the one or more bounding regions is based on locations of text bounding regions in multiple frames.

7. The computer-readable medium of claim 6, wherein the select a location of a text bounding region in the frame that does not overlap with the one or more bounding regions is based on locations of text bounding regions in multiple frames of the video and reduces an amount of movement of the locations of text bounding regions in multiple frames.

8. The computer-readable medium of claim 1, wherein the select a location of a text bounding region in the frame that does not overlap with the one or more bounding regions is based on a per-pixel raster order scan of a frame.

9. The computer-readable medium of claim 1, wherein the select a location of a text bounding region in the frame that does not overlap with the one or more bounding regions comprises reduce a size of the bounding region in the frame until identifying a location of a text bounding region in the frame that does not overlap with the one or more bounding regions.

10. The computer-readable medium of claim 1, wherein the frame of video comprises one or more of: text, audio, graphics, video, holographic images or video, or audio.

11. An apparatus comprising:
at least one processor and
at least one memory comprising stored thereon, that if executed by the at least one processor, cause the at least one processor to:
for a frame of a video file:
identify one or more bounding regions in the frame that correspond to regions of interest;
select a location of a text bounding region in the frame that does not overlap with the one or more bounding regions, wherein the text bounding region in the frame is associated with text; and
cause the text to be displayed in the text bounding region corresponding to the selected location.

12. The apparatus of claim 11, wherein the identify one or more bounding regions in the frame that correspond to regions of interest is based on a neural network trained based on regions of interest.

13. The apparatus of claim 11, wherein the regions of interest comprise one or more of: a largest image in a frame, a moving image, a centered image, text, or an image of a human.

14. The apparatus of claim 11, wherein the text to be displayed in the region comprises subtitles or closed captioning (CC) text.

15. The apparatus of claim 11, wherein the select a location of a text bounding region in the frame that does not overlap with the one or more bounding regions is based on locations of text bounding regions in multiple frames.

16. The apparatus of claim 11, wherein the select a location of a text bounding region in the frame that does not overlap with the one or more bounding regions is based on a per-pixel raster order scan of a frame.

17. A method comprising:
for frames of a video file:
determining a location of subtitle text by:
based on a user-input configuration specifying to select a location of display of the subtitle text to avoid images of interest:
determining one or more regions of interest in the frame and
selecting a location of the subtitle text to avoid overlapping a bounding box surrounding the subtitle text with the one or more regions of interest.

18. The method of claim 17, wherein the regions of interest comprise one or more of: a largest image in a frame, a moving image, a centered image, text, or an image of a human.

19. The method of claim 17, wherein the selecting a location of the subtitle text to avoid overlapping a bounding box surrounding the subtitle text with the one or more regions of interest is based on a per-pixel raster order scan of a frame.

20. The method of claim 17, wherein the selecting a location of the subtitle text to avoid overlapping a bounding box surrounding the subtitle text with the one or more regions of interest comprises reducing a size of the bounding box in the frame until identifying a location of the bounding box in the frame that does not overlap with the one or more regions of interest.
